(19) United States
(12) Patent Application Publication
(10) Pub. No.: US 2008/0100156 A1
(43) Pub. Date: May 1, 2008

(54) Method and Device for Compensating Vibrations of an Electrical Machine, and Electrical Machines Comprising One such Device

(75) Inventors: Mohamed Khemis Gabsi, Cachan (FR); Xavier Mininger, Thiais (FR)

Correspondence Address: MATTHEW R. JENKINS, ESQ., 2310 FAR HILLS BUILDING, DAYTON, OH, 45419, US

(73) Assignees: CENTRE NATIONAL DE LA RECHERCHE SCIENTIFIQUE, Paris Cedex 16 (FR); ECOLE NORMALE SUPERIEURE DE CACHAN, Cachan (FR)

(21) Appl. No.: 11/574,589

(22) PCT Filed: Sep. 5, 2005
(86) PCT No.: PCT/FR05/02205

§ 371 Date: Sep. 20, 2007

(30) Foreign Application Priority Data
Sep. 3, 2004 (FR) 0409364

(51) Int. Cl. H02K 1/12; H02K 11/00; H02K 5/24; H02N 2/00; F16F 15/22

(52) U.S. Cl. 310/51; 310/317; 318/460

(57) ABSTRACT

A method of compensating vibration of an electrical machine comprising a stator and a moving portion, said stator being subjected to magnetic forces generated by alternating electrical excitation and leading to deformation thereof. The method comprises exciting piezoelectric actuators secured at predetermined action locations on the outside surface of the stator, said piezoelectric actuators being arranged to produce controlled deformation in said stator to counter the deformation induced by the magnetic forces.

### BACKGROUND OF THE INVENTION

1. Field of the Invention

The present invention relates to a method of compensating vibration of an electrical machine. The invention also relates to a compensation circuit implementing the method of the invention, and to electrical machines fitted with the circuit.

The term electrical machine is used herein to mean any electromechanical converter operating as a motor or a generator, of rotary or linear structure, and regardless of its shape. It may be a conventional electrical machine such as a direct current (DC) machine, an asynchronous machine or a synchronous machine, with or without permanent magnets, or it could equally well be a non-conventional electrical machine or a special machine such as a variable reluctance machine or a hybrid machine. The magnetic circuit of the stator may be implemented in the form of a stack of laminations of ferromagnetic material or by molding or by any other available technique.

The vibration of the stator of an electrical machine in operation imparts motion to the surrounding air, thereby emitting soundwaves. The origin of such vibration lies in the various stresses that are applied to the stator. Electromagnetic forces, and in particular the radial components thereof, often represent the main cause of such vibration. Mechanical or aerodynamic friction can also cause troublesome vibration, particularly at high speeds.

2. Description of Related Art

The purpose here is to minimize such vibration and thus minimize the acoustic noise of electrical machines in order to improve the comfort of the users of such machines and avoid damaging their health, in particular to avoid risk of professional deafness.

In the past, numerous attempts have been made to achieve a relative reduction in noise by designing and powering electrical machines in suitable manner.

Various noise-reduction means based on designing and powering actuators have been proposed. However those noise-reduction means present limits in terms of effectiveness, in particular at high speeds. The reductions obtained are therefore insufficient and noise remains a major concern both for the manufacturers of machines and for their users.

There also exist compensation techniques making use of electromagnetic forces. Suitably powered windings are added for generating forces in opposition to those that generate the noise. The main problems associated with that method are the need to deliver high powers in order to power the compensation windings, and the magnetic interaction that occurs between the main windings and the compensation windings, which makes control difficult.

### SUMMARY OF THE INVENTION

The object of the present invention is to remedy those drawbacks by proposing a method of compensating effectively the vibration of an electrical machine.

According to the invention, the compensation method for compensating vibration of an electrical machine comprising a stator and a moving portion, where the stator is subjected to magnetic forces generated by alternating electrical excitation leading to deformation thereof, is characterized in that it comprises exciting piezoelectric actuators fixed at predetermined action locations on the outside surface of said stator, said piezoelectric actuators being arranged to produce controlled deformation in said stator to counter the deformation induced by the magnetic forces.

Thus, in order to reduce the vibration of an electrical machine, the invention proposes using piezoelectric actuators adhesively bonded to the stator and controlled appropriately. Under the action of an electrical voltage, such actuators lengthen or shorten, thereby deforming the structure of the machine. That deformation, in opposition to the deformation generating the audible noise, cancels any vibration from the stator. Such piezoelectric actuators can be made using lead zirconium titanate (PZT) material.

The positioning of the piezoelectric actuators has been determined by simulations based on finite element calculations, the purpose being firstly to increase the efficiency of the actuators and secondly to minimize the number thereof.

Advantageously, the excitation of the piezoelectric actuators is controlled substantially in phase opposition relative to the magnetic forces to which the stator is subjected, at a frequency that is twice the frequency of the alternating electrical excitation.

In a preferred embodiment of the invention, the compensation method of the invention further comprises servo-control of a signal for exciting the piezoelectric actuators as a function of an acceleration measurement taken at the outside surface of the stator at a predetermined measurement point.

When the compensation method is implemented on a rotary electrical machine having n pairs of stator poles, the vibration compensation is provided by two diametrically opposite piezoelectric actuators situated on an axis of symmetry of the stator, said piezoelectric actuators being arranged to generate deformation forces that are substantially orthogonal to said axis of symmetry.

According to another aspect of the invention, there is provided a compensation circuit for compensating vibration of an electrical machine comprising a stator and a moving portion, said stator being subjected to magnetic forces generated by alternating electrical excitation produced by electrical power supply means and causing it to be deformed, the circuit being characterized in that it comprises:

piezoelectric actuators secured at predetermined action locations on the outside surface of said stator, said piezoelectric actuators being arranged to produce controlled deformation in said stator to counter the deformation induced by the magnetic forces;

excitation means for exciting said piezoelectric actuators; and

control means for controlling said excitation means synchronously with the electrical power supply means of the machine.

When the circuit is implemented for a rotary electrical machine having n pairs of stator poles, the piezoelectric actuators are secured on outside surface zones of the stator that are substantially plane and diametrically opposite on an axis of symmetry of said stator.

In a particular embodiment of the invention, each piezoelectric actuator is substantially in the form of a thin elongate parallelepiped extending lengthwise over all or part of the length of said stator, and heightwise over all or part of an arc interconnecting the two bases of two adjacent poles of said stator.

Each piezoelectric actuator is provided with two excitation electrodes connected in parallel to the excitation means.

In a first version of the invention with servo-control, the compensation circuit further comprises measurement means for measuring radial acceleration at the outside surface of the stator at a point situated substantially radially in line with a stator pole, and the excitation means and the control means are arranged to servo-control the excitation voltage in a manner that is adjusted to minimize the acceleration signal delivered by the radial acceleration measurement means.

In a second version of the invention with servo-control, the compensation circuit further comprises indirect means for indirectly generating information concerning the magnetic forces acting on a pole and/or the radial acceleration at the surface of the stator, said information being delivered to the control means for controlling the excitation means in servo-control mode.

These indirect means may comprise means for measuring the magnetic flux in a pole of the stator, and means for deducing from said flux measurement information about acceleration.

In yet another aspect of the invention, there is provided an electrical machine fitted with a compensation circuit of the invention, the electrical machine having a stationary portion or stator and a moving portion, the machine being characterized in that the stator is provided with piezoelectric actuators secured at predetermined zones of the outside surface of said stator, said piezoelectric actuators being disposed to generate mechanical forces on the stator to counter the magnetic forces to which the stator is subjected.

Other advantages and characteristics of the invention appear on examining the detailed description of a non-limiting embodiment, and the accompanying drawings.

### BRIEF DESCRIPTION OF THE DRAWINGS

FIGS. 1A and 1B show the influence of deformation of a piezoelectric pellet made of PZT stuck on an outside structure of the stator of an electrical machine having projecting poles, the deformation being respectively in elongation and in contraction;

FIG. 2 is a diagram of an electromagnetic model designed to validate the compensation method of the invention;

FIG. 3 is a theoretical diagram of the electrical circuit of the FIG. 2 model;

FIG. 4 shows the influence on the measured acceleration of the voltage level applied to a piezoelectric pellet

FIG. 5 shows a display of deformation nodes on the stator of the validation model, provided with two piezoelectric pellets that are diametrically opposite;

FIG. 6 shows the mode 2 deformation suffered by the stator of the validation model;

FIG. 7 is a diagram showing the optimum dimensions for piezoelectric pellets for a given shape of stator;

FIG. 8 is a comparison between two acceleration spectra respectively as measured and as calculated by a finite element method, for current excitation e;

FIG. 9 is a comparison between two acceleration spectra respectively as measured and as calculated by a finite element method, when exciting compensation piezoelectric pellets;

FIG. 10 is a block diagram of a circuit designed to generate two synchronized signals, respectively for feeding to a stator coil and for exciting the piezoelectric pellets, for implementing the compensation method of the invention; and

FIG. 11 is a diagram of a servo-control circuit, designed to generate a signal for exciting piezoelectric pellets that is servo-controlled on an acceleration measurement.

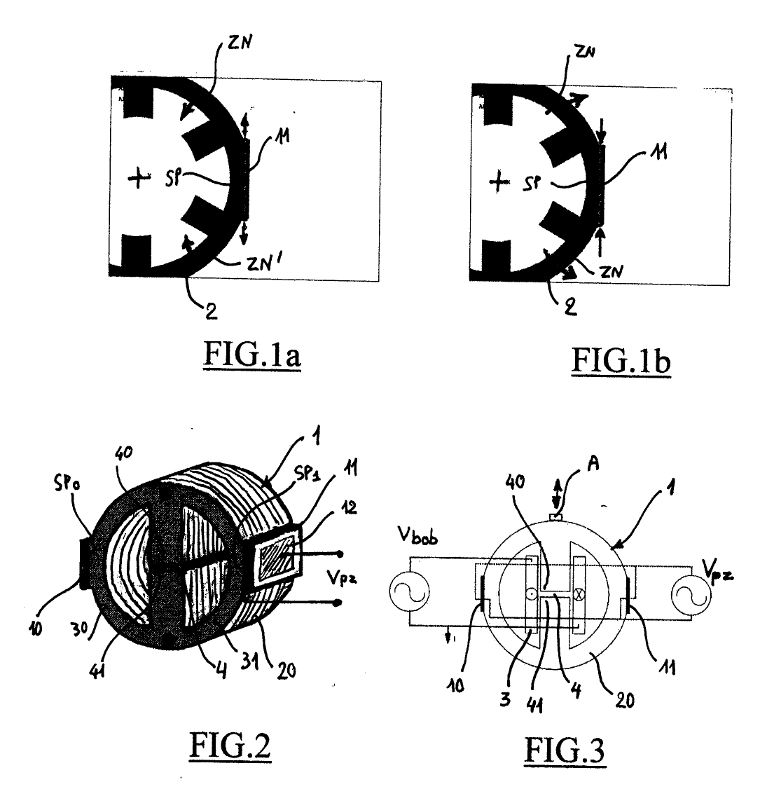

The physical principle on which the compensation method of the invention is based consists in compensating mechanical deformations suffered by stator laminations 2 subjected to electromagnetic forces, by inducing either elongation or contraction of determined action zones located on the outside surfaces of the stator laminations, by means of piezoelectric actuators stuck on said determined zones. Thus, as shown in FIG. 1A, an elongation of the piezoelectric pellet 11 stuck on an action zone SP leads to a deformation of stator zones ZN and ZN′ towards the inside, countering the deformations of said zones as induced by electromagnetic forces. Conversely, contraction of the piezoelectric pellets 11 leads to outward deformation of the stator zones ZN, ZN′.

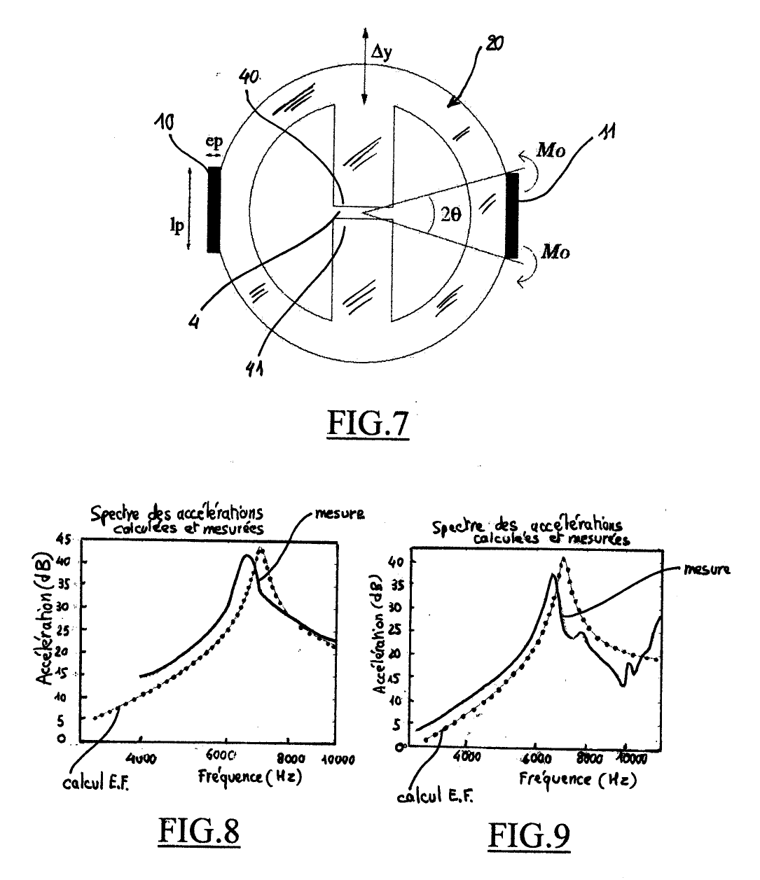

With reference to FIGS. 2 to 7, there follows a description of a practical example embodying and validating the method of the invention, making use of a validation model. With reference to FIG. 2, the electromagnetic model 1 comprises a magnetic circuit having two diametral poles 40, 41 separated by a central airgap 4, and a yoke in the form of two semicircular return arms 30, 31 each provided on its outside surface with a respective plane action zone SP0, SP1 in quadrature relative to the axis of the diametral poles, and each designed to receive a piezoelectric pellet 10, 11 acting as a compensation actuator. Each piezoelectric pellet 10, 11 is provided with two excitation electrodes, including an electrode 12 placed on the outside surface of the pellet, with a voltage Vpz being applied to the terminals thereof, see FIGS. 2 and 3.

The validation model further comprises an excitation coil 3 designed to surround both diametral poles 40, 41 and powered by an alternating current (AC) voltage generator V_{coil}, and an accelerometer A placed on the outside surface of the magnetic circuit, substantially on the same axis as the diametral poles 40, 41. The two diametrically opposite piezoelectric pellets 10, 11 are excited in parallel from an AC voltage generator Vpz.

When the magnetic circuit of the validation model 1 is subjected to an alternating magnetic field created by AC flowing in the coil 3, the ends of the diametral poles 40, 41 separated by the airgap 4 are subjected to attraction forces that lead to symmetrical alternating deformation of the magnetic circuit, thus leading in particular to an output signal from the accelerator A.

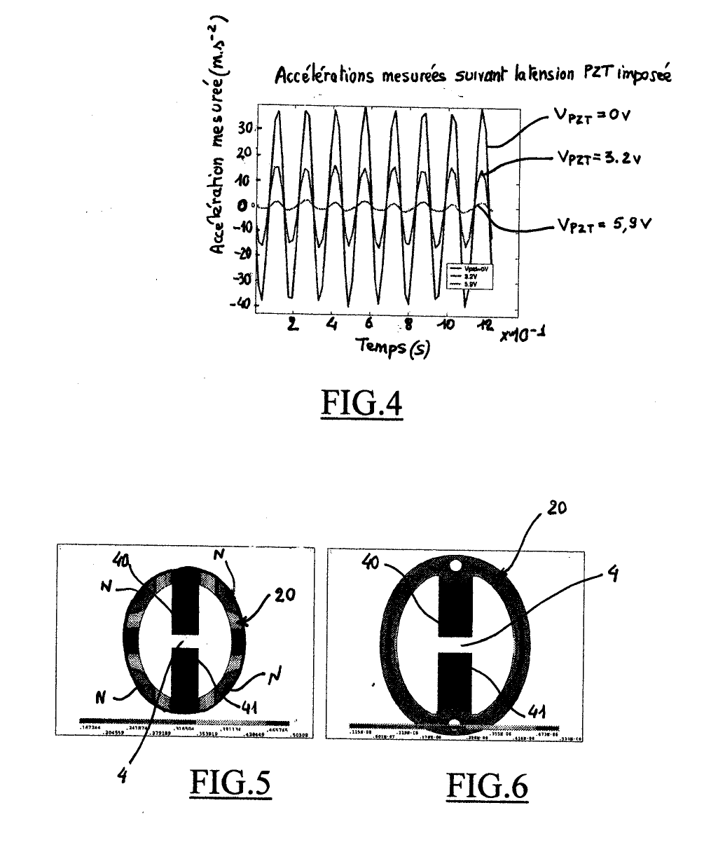

Thus, with reference to FIG. 4, amplitude modulation can be observed in the acceleration signal as a function of the voltage applied to the terminals of the piezoelectric pellets 10, 11. The greater the applied voltage Vpz, the more the amplitude of the acceleration is diminished, and consequently the less the noise. Studies and simulations of the modes of vibration of the magnetic circuit have led to it being recommended to use only two pellets so as to conserve the symmetry of the magnetic structure and avoid mode 3 vibration. Inspection of the nodes N in FIG. 5 corresponding to simulating mode 2 vibration, and inspection of the deformation of the magnetic circuit in mode 2 as shown in FIG. 6, leads to recommending placement of the piezoelectric pellets on the axis that is orthogonal to the axis of the poles.

Studies in mechanics have been performed in order to find the optimum dimensions for the piezoelectric pellets, taking account firstly of a relationship between the linear moment Mo on each piezoelectric pellet 10, 11 and the voltage Vpz applied to the electrodes of the pellets, and secondly of a relationship between the deformation □y at the point where acceleration is measured and the linear moment Mo. That study has shown that there exists an optimum thickness ep for the piezoelectric pellet, which for the validation model is a little more than 2 millimeters (mm), and that the deformation □y is proportional (in static mode) to the length λp of the pellet.

When the frequency of the current fed to the excitation coil 3 is varied, a response spectrum of the acceleration (A) is observed that is of the type shown in FIG. 8, with there being quite a good match between the spectrum as measured and the spectrum as calculated by a finite element method. If the piezoelectric pellets are excited at variable frequency, then a response spectrum of the acceleration (A) is observed of the type shown in FIG. 9, which is close to that observed with current excitation, in particular concerning the resonant frequencies.

In order to obtain maximum efficiency in vibration compensation and in noise reduction, the piezoelectric pellets must be powered so as to oppose the displacements due to the magnetic forces. Calculation has shown that for a force of 1.1 newtons (N) imparted to the teeth of a machine, a electromagnetic excitation voltage of less than 7 V suffices for canceling the displacements in the magnetic circuit. It has also been established that synchronization is necessary between the electromagnetic excitation and the compensating piezoelectric excitation.

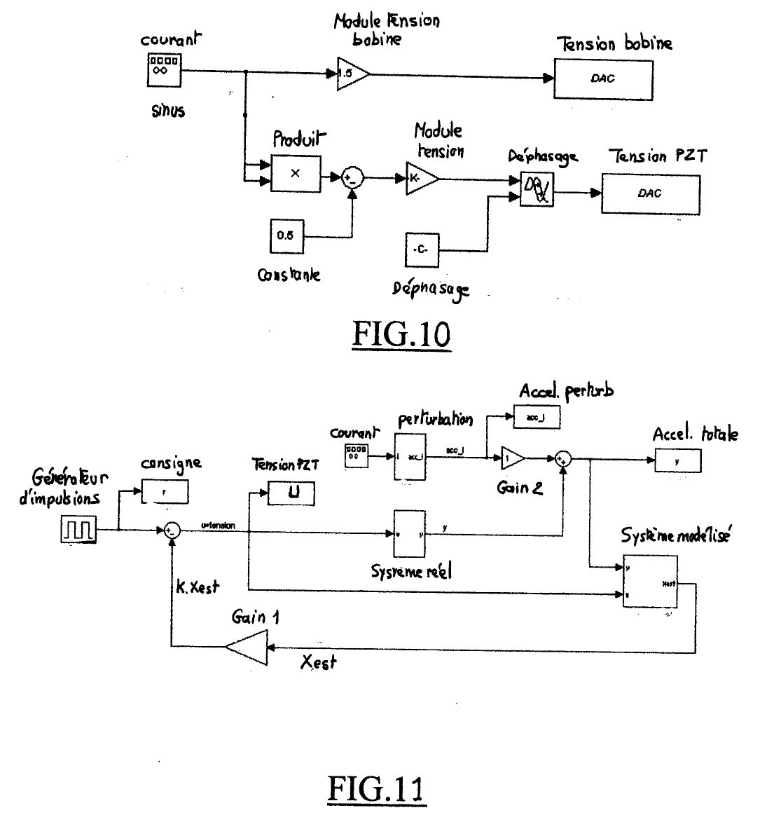

There are various ways of producing two synchronized excitation signals, and they include a technique consisting in using the software tool Matlab Simulink□ associated with a Dspace□ module, as shown in FIG. 10. The control circuit implemented in this way enables a double frequency signal to be obtained by means of the “product” function. A first digital-to-analog converter DAC generates a voltage V_{coil} for powering the coil 3, e.g. at a frequency of 3.3 kilohertz (kHz), while a second digital-to-analog converter generates a voltage Vpz from the double frequency signal and after appropriately adjusting phase shift.

In order to compensate vibration effectively under variable speed conditions, and thus at variable velocity, it is necessary to servo-control the excitation of the piezoelectric pellets so as to minimize the acceleration measured by the accelerometer A. It has been established that conventional servo-control methods cannot be used which is why a state model is used, as shown in FIG. 11. A transfer function H(p) is implemented that corresponds to a second order highpass filter, in which only mode 2 is used. The piezoelectric actuators are thus controlled in phase opposition relative to the magnetic forces responsible for the vibration.

It should be observed that it is also possible to provide a version of the compensation circuit of the invention in which the acceleration information is obtained indirectly, without requiring the use of an accelerometer. For example, provision can be made to measure the flux in a stator pole, to process the measurement, and deduce therefrom, via a model for the relationship between flux, magnetic force, and acceleration, an estimate of the instantaneous acceleration in the stator at the pole in question. Such processing can be implemented in a specialized circuit.

The power supply voltage to the piezoelectric actuators remains low (a few volts for the example studied) and the power required is delivered by a small signal electronic circuit.

By way of non-limiting example, for a variable reluctance machine having a stator of length 60 mm, each actuator pellet of PZT material may have a thickness of about 1 mm, a height of about 13 mm, and a length of about 60 mm.

The PZT material used for making the actuator pellet may have the following formula;

Pb_{0.89} (Ba, Sr)_{0.11}(Zr_{0.52}Ti_{0.48})O₃

doped with 1% manganese and containing 1% fluorine.

For selecting and producing piezoelectric actuators suitable for use in a compensation circuit of the invention, reference may usefully be made to the work undertaken by Laboratoire de Génie Electrique et de Ferroélectricite (LGEF) [Electrical and ferroelectric engineering laboratory] at Institut National de Sciences Appliquées(INSA) [National Institute of Applied Sciences] at Lyon. The adhesive used for sticking the actuator pellets on the zones of the stator that receive them may be epoxy adhesive.

Although the above-described experimental validation was performed on a variable reluctance structure, the present invention can be applied to any type of electrical machine.

Naturally, the invention is not limited to the examples described above, and numerous modifications can be applied to those examples without going beyond the ambit of the present invention.

While the method herein described, and the form of apparatus for carrying this method into effect, constitute preferred embodiments of this invention, it is to be understood that the invention is not limited to this precise method and form of apparatus, and that changes may be made in either without departing from the scope of the invention, which is defined in the appended claims.

What is claimed is:

1. A compensation method for compensating vibration of an electrical machine comprising a stator and a moving portion, said stator being subjected to magnetic forces generated by alternating electrical excitation leading to deformation thereof, the method comprising the steps of exciting piezoelectric actuators fixed at predetermined action locations on an outside surface of said stator, said piezoelectric actuators being arranged to produce controlled deformation in said stator to counter the deformation induced by the magnetic forces.

2. The compensation method according to claim 1, characterized in that the excitation of the piezoelectric actuators is controlled substantially in phase opposition relative to the magnetic forces to which the stator is subjected.

3. The compensation method according to claim 1, characterized in that the excitation of the piezoelectric actuators is implemented at a frequency that is twice the frequency of the alternating electrical excitation.

4. The compensation method according to claim 1, characterized in that it further comprises servo-control of a signal for exciting the piezoelectric actuators as a function of an acceleration measurement taken at the outside surface of the stator at a predetermined measurement point.

5. The compensation method according to claim 1, implemented on a rotary electrical machine having n pairs of stator poles, the method being characterized in that vibration compensation is provided by two diametrically opposite piezoelectric actuators situated on an axis of symmetry of the stator, said piezoelectric actuators being arranged to generate deformation forces that are substantially orthogonal to said axis of symmetry.

6. A compensation circuit for compensating vibration of an electrical machine comprising a stator and a moving portion, said stator being subjected to magnetic forces generated by alternating electrical excitation produced by electrical power supply means and causing it to be deformed, wherein said circuit comprises:
plurality of piezoelectric actuators secured at predetermined action locations on an outside surface of said stator, said plurality of piezoelectric actuators being arranged to produce controlled deformation in said stator to counter the deformation induced by the magnetic forces;
excitation means (Vpz) for exciting said piezoelectric actuators; and
control means for controlling said excitation means synchronously with the electrical power supply means of the machine.

7. The compensation circuit according to claim 6, implemented for a rotary electrical machine having n pairs of stator poles, wherein said plurality of piezoelectric actuators are secured on a plurality of outside surface zones, respectively, of the stator that are diametrically opposite on an axis of symmetry of said stator.

8. The compensation circuit according to claim 7, wherein each of said plurality of piezoelectric actuators is substantially in the form of a thin elongate parallelepiped extending lengthwise over all or part of the length of said stator, and heightwise over all or part of an arc interconnecting the two bases of two adjacent poles of said stator.

9. The compensation circuit according to claim 6, wherein each of said plurality piezoelectric actuators is provided with two excitation electrodes connected in parallel to the excitation means.

10. The compensation circuit according claim 6, wherein it further comprises measurement means (A) for measuring radial acceleration at the outside surface of the stator at a point situated substantially radially in line with a stator pole, and in that the excitation means (Vpz) and the control means are arranged to servo-control the excitation voltage in a manner that is adjusted to minimize the acceleration signal delivered by the radial acceleration measurement means.

11. The compensation circuit according to claim 6, wherein it further comprises indirect means for indirectly generating information concerning the magnetic forces acting on a pole and/or the radial acceleration at the surface of the stator, said information being delivered to the control means for controlling the excitation means (Vpz) in servo-control mode.

12. The compensation circuit according to claim 11, wherein said indirect means comprises means for measuring the magnetic flux in a pole of the stator.

13. An electrical machine fitted with a compensation circuit according to claim 6, the electrical machine having a stationary portion or stator and a moving portion, wherein the stator is provided with said plurality of piezoelectric actuators secured at predetermined zones of the outside surface of said stator, said plurality of piezoelectric actuators being disposed to generate mechanical forces on the stator to counter the magnetic forces to which the stator is subjected.

14. The rotary electrical machine according to claim 13, in which said stator comprises n pairs of stator poles, wherein said outside surface of said stator includes over all or part of its length two diametrically opposite substantially plane zones on an axis of symmetry of said stator, each designed to receive a compensation piezoelectric actuator.

15. The rotary electrical machine according to claim 14, wherein said stator is provided with means for delivering directly or indirectly information concerning the radial acceleration to which a pole of said stator is subjected.

16. A system for controlling deformation of a stator in an electric motor comprising:
a plurality of piezoelectric actuators for situating on the stator; and
a excitation circuit coupled to said plurality of piezoelectric actuators;
said excitation circuit energizing said plurality of piezoelectric actuators to produce controlled deformation in the stator to counter deformation induced by the magnetic forces.

17. The system for controlling deformation of a stator according to claim 16, implemented for a rotary electrical machine having n pairs of stator poles, wherein said plurality of piezoelectric actuators are secured on a plurality of outside surface zones, respectively, of the stator that are diametrically opposite on an axis of symmetry of said stator.

18. The system for controlling deformation of a stator according to claim 17, wherein each said plurality of piezoelectric actuators is substantially in the form of a thin elongate parallelepiped extending lengthwise over all or part of the length of said stator, and heightwise over all or part of an arc interconnecting the two bases of two adjacent poles of said stator.

19. The system for controlling deformation of a stator according to claim 16, wherein each of said plurality piezoelectric actuators is provided with two excitation electrodes connected in parallel to the excitation means.

20. The system for controlling deformation of a stator according claim 16, wherein it further comprises measurement means (A) for measuring radial acceleration at the outside surface of the stator at a point situated substantially radially in line with a stator pole, and in that the excitation means (Vpz) and the control means are arranged to servo-control the excitation voltage in a manner that is adjusted to minimize the acceleration signal delivered by the radial acceleration measurement means.
